(19) United States
(12) Patent Application Publication
(10) Pub. No.: US 2007/0183671 A1
(43) Pub. Date: Aug. 9, 2007

(54) METHOD FOR COMPRESSING DATA, METHOD FOR DECOMPRESSING COMPRESSED DATA, AND DEVICES FOR IMPLEMENTING THESE OPERATIONS

(76) Inventors: Matthias Gotz, Freiburg (DE); Thomas Sohne, Waldkirch (DE)

Correspondence Address: O'Shea, Getz & Kosakowski, P.C., Suite 912, 1500 Main Street, Springfield, MA, 01115, US

(21) Appl. No.: 11/615,474

(22) Filed: Dec. 22, 2006

(30) Foreign Application Priority Data
Dec. 22, 2005 (DE) 10 2005 062 077.9

(51) Int. Cl. G06K 9/36

(52) U.S. Cl. 382/232

(57) ABSTRACT

A sequence of data (b) entered into a compression device is selectively either compressed or not compressed, then supplied by the compression device as compressed or uncompressed data (b°, s°). A status information item (S) in a sequence of supplied data (b° , s°) is overwritten by the compression device through at least one value of the supplied data before being supplied. The sequence of supplied data (b°, s°) is composed of compressed and uncompressed data (b°, s°).

### PRIORITY INFORMATION

This patent application claims priority from German patent application 10 2005 062 077.9 filed Dec. 22, 2005, which is hereby incorporated by reference.

### BACKGROUND OF THE INVENTION

The invention relates to the field of video processing, and in particular to compressing and decompressing video data.

Due to increasing image resolutions and image qualities, modem video processing systems place increasingly greater demands on the size and speed of video memories. The use of techniques for data compression represents an effective mechanism of utilizing an existing memory more effectively and reducing the memory access rate. Since data compression can result in a degradation of the image quality, however, it should be employed only when, for example due to limited bandwidth, certain ancillary functions are possible only by compressing the image data. For this reason, it would be advantageous to turn compression and decompression on and off during continuous operation.

The goal of data compression should be to enhance the performance of image signal processing or video signal processing systems. However, with functions that require both undelayed and delayed image data, switching between compressed and uncompressed data results in errors during the switching process, these errors in the image becoming noticeably objectionable.

In the event image processing functions are employed that must access varyingly delayed then image errors are created during switching since delayed and undelayed images do not have the same compression status data—for example, data delayed by one or more fields or frames—as may be the case, for example, in a de-interlacer or frame rate converter,. A de-interlacer converts video fields to frames by doubling the image lines. During switching, or during a period after switching, compressed data are erroneously considered to be uncompressed data, and vice versa. In the worst case, multiple successive images can a be completely destroyed—for example, by spurious colors. This would become conspicuous on the display screen as objectionable image flickering and is unacceptable.

To prevent this problem, the current approach is to avoid switching during continuous operation. Accordingly, no data compression is used. As a result, however, it is not possible to implement certain ancillary functions that would require a higher memory access rate. In an alternative procedure, the image data are always compressed. As a result, however, in such cases where in fact no compression would be required, optimum image quality is not attainable.

### SUMMARY OF THE INVENTION

A sequence of data entered into a compression device is selectively compressed, and then supplied by the compression device either as compressed or uncompressed data. Before supplying the data a status information item in a sequence of the supplied data through at least one value of the supplied data is overwritten by the compression device, where the sequence of supplied data is composed of compressed and uncompressed data, and the status information item indicates whether or not segments of the supplied data are compressed.

Useful data as well as control data may be compressed/decompressed and stored. In video processing or image signal processing, the control data are composed of synchronization information as well as control data that identify the active image contents. The control data are used to synchronize the individual blocks and to indicate to the memory which data are to be stored. This prevents, among other things, non-visible image regions—for example, a horizontal or vertical blanking interval—from being stored unnecessarily. However, the control data itself does not necessarily have to be stored.

Preferably, the status information item is inserted at unambiguously assigned positions of the sequence of supplied data. The unambiguously assigned positions may be assigned to a specific bit within a cyclic bit sequence or cyclic frame sequence within the sequence of supplied data. The unambiguously assigned positions may also be assigned as a function of a switching signal assigned to the entered sequence of data to switch between a compression or non-compression mode.

Both useful data as well as control signals (e.g., permanently assigned to the useful data) may be compressed. The supplied data may be stored in a memory.

For purposes of simplification, the status information item may be written through actual useful data or control data with the loss of one useful data information item and/or control signal information item.

The entered sequence of data is preferably composed of image data. The status information item is written through at least one luminance value, where subsequent chrominance values are selectively compressed or not compressed. At least one portion of the luminance values is accordingly not compressed in order to easily to read out the status information item.

In one embodiment a method includes decompressing a sequence of data in partially compressed form, in particular, decompressing supplied data that has been partially compressed, where a status information item has been inserted in the sequence of supplied data, where the status information item is inserted by a decompression device either to decompress the supplied data as compressed data or not to decompress uncompressed data, and outputting data in the form of decompressed or uncompressed data to a data processing device and/or an output.

During compression of the supplied data and/or during subsequent data processing, a delay is effected through a specific cyclic bit sequence or frame sequence.

The techniques of the present invention are based on the principle that information items on the image status, or on the compression status of the image data, have been or are appropriately embedded in a data stream of such data such that automatic error-free processing of data read from a memory is implementable independently of the actual switching operations. In particular, the techniques provide for optimum utilization of existing resources by enabling data compression to be switched on and off during continuous operation. To this end, status information items are embedded at defined positions in the data stream, that enable the data compression to detect the compression status at all times, and thus to continue to process in an error-free manner both the data delayed by the memory, or data received in delayed form from an interface, as well as undelayed data.

The techniques of the present invention are employable in particular wherever compressed image data are stored, such as, for example, in de-interlacers, frame rate conversions, or picture-in-picture applications. Advantageously, the techniques are not limited to the use of data compression to be performed, nor are they limited to a specific data compression.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 is a block diagram illustration of a system for compressing, storing, and decompressing image data; and

FIG. 2 illustrates examples of data sequences before a compression or after a compression stage, wherein in the first case compression is turned off while in the second case compression is turned on.

### DETAILED DESCRIPTION OF THE INVENTION

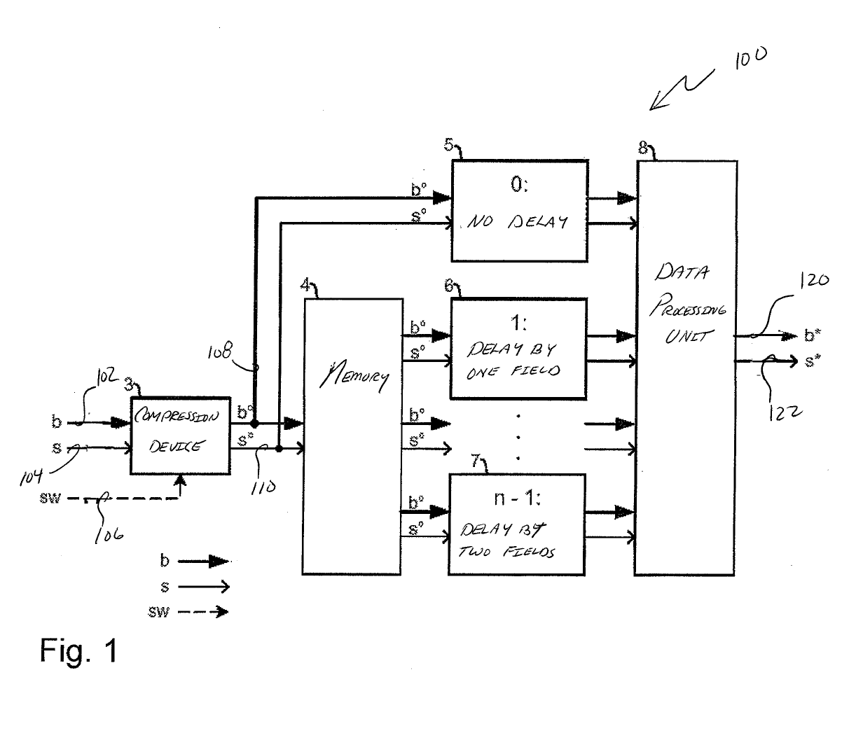

FIG. 1 is a block diagram illustration of a system 100 for receiving, selectively compressing, storing, selectively decompressing, and processing image data. The system 100 receives image data and control signals are received on lines 102, 104, respectively. Switching signals are received on line 106. The image data, control signals on the line 104 and the switching signals are applied to a compression device 3. The compression device 3 compresses the image data on the line 102, and optionally the control signals on the line 104 as well, when an appropriate switching signal on the line 106 is applied. Otherwise the image data are passed on uncompressed.

The switching signals on the line 106 can thus be used to determine whether or not compression should be implemented for certain data segments of a sequence of entered data. Alternatively, given an appropriate design, the compression device 3 can itself decide whether or not certain segments of a sequence of entered data should be compressed—with the result that the switching signal on the line 104 may be eliminated.

The compression device 3 outputs the appropriately compressed or uncompressed image data on the line 108 and control signals on the line 110 as supplied data to an image memory 4 in which the corresponding data and signals on the lines 108 and 110 are stored. The data on the lines 108, 110 are also provided to a decompression device 5 that operates without a delay. In parallel to this first decompression device 5, any desired number of additional decompression devices 6 for a delay by a field, up to a decompression device 7 for a delay by n−1 fields or images, are provided. In order to supply the decompression devices 5, 6, 7 with corresponding image data, the image data are requested and supplied by the image memory 4.

After image data are fed from the image memory 4 to the decompression device 5-7 and compressed segments of the supplied image data b° are decompressed, image processing is performed in a central control device or image processing unit. The image processing is accommodated, by way of example, in a data processing device 8 that supplies appropriately processed image data b* and control signals s* on lines 120, 122, respectively.

The compression can be turned on and off at any given instants by the compression device 3 according to the state of the switching signal sw. The compression operation is turned on or off preferably as a function of the switching signal sw, as well as a function of a delay specified by the control signals s on the lines 104—for example, synchronously with the horizontal or vertical synchronization pulses. The status of compression may be embedded in the data stream.

The data read from the memory are delayed by one or more fields. A function of this type can also access an undelayed data stream. Since the image processing does not receive the compression status through the switching signal, but instead reconstructs its from the data stream, the approach ensures that the data are treated correctly in every case. The situation therefore cannot arise in which, after compression is turned on, as yet uncompressed data is read from the memory 4 and this data is erroneously treated as compressed data, since a switching signal, which is now unnecessary for the decompression, indicates that compressed data is present.

An embedding and reconstruction of such status information items in the data stream is preferably implemented by overwriting the image data b, and/or the control signals s. For purposes of compression, the most negligible possible effect on the visible image components is preferred. In addition, reconstruction of the status information item, which is dependent on the compression technique used, should be available. During reconstruction of compressed data, attention should be paid to whether the data is compressed or uncompressed. The status information item should thus be located at a defined site which is independent of the compression status.

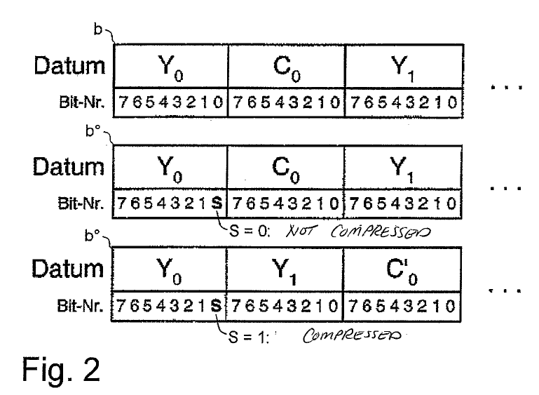

FIG. 2 illustrates, by way of example, positions of the status information item given a 4:2:2/4:1:1 compression. The following discussion describes, by way of example, the embedding and reconstruction of the status information item—that is, the information as to whether compressed or uncompressed data are present—for a compression method that converts image signals provided in the 4:2:2 format with 16 bits per pixel to the 4:1:1 format with 12 bits per pixel. In the event the status information item is composed of one bit (data compressed/uncompressed), the following procedure can be employed.

The first, or optionally also x^{th}, valid pixel after an event defined by control signals s—for example, in the form of a horizontal or vertical synchronization pulse—is overwritten with the status information item S. At these instants, switching of the compression mode or status, and thus of the decompression mode or status as well, is possible. Since the first pixel is generally in any case not visible later on, any image errors caused by status information item S are reduced.

Since a processing of this type modifies, in particular, only the luminance value, and not the chrominance value, any effect from status information item S on the visible image can be further reduced by using for status information item S the least significant bit, or in the case of, for example, multiple embedded information items, the least significant bits of the first luminance value. This position of the bit is identical for both compressed as well as uncompressed data.

FIG. 2 illustrates data b of an image signal in a first line before being fed to the compression device 3. An exemplary datum of data b is composed of a zero luminance value pixel Yᵢ and extends over bit numbers 0-7. Uncompressed chrominance value pixels Cᵢ follow for uncompressed data over the, for example, next 8 bit numbers. Finally, this is followed, in the embodiment shown, by a luminance value Yᵢ behind chrominance value Cᵢ similarly with 8 bits or 8 bit numbers each.

The center line shows a datum for the situation of being passed through the compression device 3 (FIG. 1) without implementation of compression. The first bit number 0 of the first luminance value pixel here is employed as a status bit, and thus as status information item S. The status bit thus created overwrites any prior information irretrievably, in case of doubt. This is again followed by uncompressed chrominance value pixel C₀ and luminance value pixel Y₁—signaled by the corresponding status bit S=0. Finally, the third line shows the case in which the datum is composed of a first group of luminance values Y₀ and a second group of luminance values Y₁, each of which has 8 bits and accordingly 8 bit numbers. The third group includes compressed chrominance value pixels C′₀ which in this case are compressed, as signaled by the corresponding status bit S=1.

In principle, no special compression techniques must be employed. With other compression techniques that affect both the luminance information as well as the chrominance information, it may however in certain cases not be possible to use the least significant bit of the luminance value for the first pixel as the status information item. In this case, the first bit of the data stream can in general, for example, be employed for the status information item.

Modifications of these arrangements are possible based on alternative embodiments. For example, the compression and storage of data can be performed in a first unit, while the decompression and subsequent processing of data can be performed in a second unit that is independent of the first unit and has the partially compressed data transferred to it. It is also possible to eliminate buffering of such compressed data—an approach conceivable, for example, in communications systems in which compressed data are transmitted through an interface and the received compressed data are directly decompressed on the receiver side.

In addition to the described design comprising a plurality of interconnected components, implementation is also possible in an integrated design in which individual components or all the described components are accommodated in an integrated circuit device. In addition, it is also possible to divide up and distribute various components among various stand-alone devices or various stand-alone components of a higher-level arrangement. FIG. 1 as well as FIG. 2 represent just a simple schematic example.

Although the present invention has been illustrated and described with respect to several preferred embodiments thereof, various changes, omissions and additions to the form and detail thereof, may be made therein, without departing from the spirit and scope of the invention.

What is claimed is:

1. A method for compressing data, comprising the steps of:
a sequence of data (b) entered into a compression device is selectively either compressed or not compressed, then supplied by the compression device as compressed or uncompressed data (b°, s°), where
a status information item (S) in a sequence of supplied data (b°, s°) is overwritten by the compression device through at least one value of the supplied data before being supplied,
wherein the sequence of supplied data (b°, s°) is composed of compressed and uncompressed data (b°, s°), and
wherein the status information item (S) indicates whether or not segments of the supplied data (b°, s°) assigned to the status information item (S) are compressed.

2. The method of claim 1, where the status information item (S) is inserted at unambiguously assigned positions of the sequence of supplied data (b°, s°).

3. The method of claim 2, where the unambiguously assigned positions are assigned to a specific bit within a cyclic bit sequence or cyclic frame sequence in the sequence of supplied data (b°, s°).

4. The method of claim 2, where the unambiguously assigned positions are assigned in the sequence of the supplied data (b°, s°) as a function of a control signal (s) that is assigned to the entered sequence of data (b).

5. The method of claim 2, where the unambiguously assigned positions are assigned as a function of a switching signal (sw) for switching a compression mode or non-compression mode.

6. The method of claim 1, where the supplied data (b°, s°) are stored in a memory.

7. The method of claim 1, where the status information item (S) is written through actual useful data or control data with the loss of one useful-data information item and/or control signal information item.

8. The method of claim 1, where the entered sequence of data (b) is composed of image data.

9. The method of claim 8, where the status information item (S) is written through at least one luminance value (Y), and the subsequent chrominance values (C) are selectively compressed or not compressed.

10. The method of claim 9, where at least one part of the luminance values (Y) is not compressed.

11. The method of claim 1, where both the useful data (b) and the control signals (s) permanently assigned to the useful data are compressed.

12. A method for decompressing a sequence of partially compressed supplied data (b°, s°), comprising:
a status information item (S) has been inserted in the sequence of supplied data (b°, s°), where the status information item (S) is used by a decompression device to decompress the supplied data as compressed data, or not to decompress the supplied data as uncompressed data, and to output data in the form of the decompressed or the uncompressed data (b*, s*) to a data processing device.

13. The method of claim 12, where during compression of the supplied data (b°, s°) and/or during subsequent data processing, a delay is effected over a specific cyclic bit sequence or frame sequence.
